(19) United States
(12) Patent Application Publication
(10) Pub. No.: US 2004/0105715 A1
(43) Pub. Date: Jun. 3, 2004

(54) Cleaning utensils

(76) Inventors: Duncan Spelman, Lancashire (GB); Carl Stone, Lancashire (GB); Darren Brian Trowsdale, Yorkshire (GB)

Correspondence Address: James E Bradley, Bracewell & Patterson, P O Box 61389, Houston, TX, 77208-1389, US

(21) Appl. No.: 10/415,268

(22) PCT Filed: Sep. 25, 2001
(86) PCT No.: PCT/GB01/04247

(30) Foreign Application Priority Data
Oct. 27, 2000 (GB) 0026305.3
Jun. 15, 2001 (GB) 0114576.2

(51) Int. Cl. B43K 5/00; A46B 5/02

(52) U.S. Cl. 401/6; 401/205

(57) ABSTRACT

A cleaning utensil comprises a hollow, liquid-receiving handle (10) having an outlet (38), a cleaning head (12) in registry with the outlet (38) and an actuator (42) provided on the handle (10) for opening and closing the outlet (38), the actuator (42) including a valve member (54) which for opening and closing the outlet (38). The outlet (38) may be provided in a surface which interfaces with a detachable shoe (20) provided with a cleaning or scouring element (34, 36, 25) or elements, the shoe (20) having an aperture (40) which registers with the outlet (38) so as to allow liquid to flow to the cleaning/scouring element(s) (34, 36).

This invention relates to cleaning utensils.

Cleaning utensils of the type comprising a handle provided with a cleaning head are in widespread use and are typically used in conjunction with a cleaning liquid. Such utensils for example are used in the kitchen for cleaning dishes and pots, pans and the like. The cleaning head is typically in the form of a brush or scouring pad.

It is already known to produce the handle in such a way that it can be filled with cleaning liquid so that the liquid can be fed to the cleaning head during use. It is also known to produce the cleaning head as a detachable unit.

The present invention seeks to provide inter alia improvements in control of liquid supply from the liquid containing handle to the cleaning head.

According to one aspect of the present invention there is provided a cleaning utensil comprising a hollow, liquid-receiving handle having an outlet, a cleaning head in registry with the outlet and an actuator provided on the handle for opening and closing the outlet, the actuator including a valve member for opening and closing the outlet, the actuator extending from one side of the handle to the other without entering the interior of the handle.

According to a second of the present invention there is provided a cleaning utensil comprising a hollow, liquid-receiving handle having an outlet, a cleaning head in registry with the outlet and a slidable actuator provided on the handle for opening and closing the outlet, the actuator including a valve member which is slidable across the outlet to effect opening and closing.

Other features and aspects of the invention are set out below in the context of a cleaning utensil comprising a hollow, liquid-receiving handle having an outlet and having or being adapted to mount a cleaning head in registry with the outlet and an actuator for opening and closing the outlet, the actuator including a valve member to effect opening and closing.

The actuator may be a one-piece moulding incorporating the valve member.

The valve member may be so arranged that, in one position of the actuator it closes the outlet and, in a second position, it acts as a detent to hold the actuator in the second position.

In one embodiment of the invention the actuator comprises a first part located on one side of the handle and accessible to the user while holding the handle, a second part which extends through the handle and a third part which extends alongside the opposite side of the handle and is provided with the valve member.

The third part of the actuator may be in the form of a flexible tongue which biases the valve member inwardly with respect to the outlet. To this end, the outlet may be provided at the base of a recess for receiving a projection on the tongue which forms the valve member.

The valve member may be located at or adjacent one end of the flexible tongue and the arrangement may be such that sliding of the actuator relative to the handle moves the valve member from the outlet closing position into a recess and the tongue biases the valve member into the recess to provide a detect action to retain the actuator in the liquid dispensing position.

The cleaning head is preferably detachable from the handle, for instance so that more than one type of cleaning head can be used with the handle. The handle and two or more cleaning heads may be sold as a kit to allow the user to switch heads according to intended usage of the utensil.

The handle may for example have at one end a surface which interfaces with a shoe portion of the cleaning head and the shoe portion may be designed to clip on to that end of the handle.

The handle may be produced by blow moulding.

The handle may have a transverse through-bore passing from one side of the handle to the other for accommodating the actuator whereby the actuator extends through the handle without requiring sealing.

The handle and the head may be moulded from different plastics materials, e.g. the handle may be moulded from a more flexible and/or softer plastics material than the head and/or the actuator.

The handle may be composed of a recycleable and environmentally friendly plastics material such as high density polyethylene.

The head and/or the actuator may be moulded from a polypropylene.

The shoe portion may include an aperture for registry with the outlet of the handle so that liquid flow from the handle passes through the shoe into the cleaning feature or features of the cleaning head, e.g. brush bristles or a sponge or foam pad which may be provided with a scouring pad.

The shoe portion may include a pocket-defining portion for reception of the handle and a latching arrangement for coupling the head to the handle. The latching arrangement may include a projection optionally integral with the handle and having an undercut face for co-operation with a latching member on the shoe portion.

Where the handle is produced by blow-moulding, the projection may be formed integrally with the handle during the blow-moulding process.

The latching member on the shoe portion may be in the form of an aperture for receiving the handle projection with snap engagement such that one side of the aperture rides over the projection and into the undercut region of the projection.

The tongue of the actuator may be located and movable between the shoe and an adjacent surface of the handle.

In one form thereof, the head may comprise a body portion and a foam pad attached to the body portion. The foam pad may be provided with a layer of abrasive material suitable for use in scouring applications.

The foam pad may be bonded to the body portion of the head without the aid of an adhesive or glue, e.g. it may be bonded to the body portion by means of a technique such as hot air staking. To this end, the body portion may be produced with ribs or upstands for use in the hot air staking process. In this manner, potentially hazardous adhesives or glues that would normally be used for such an application can be avoided.

The handle may have an opening through which liquid can be introduced into the interior of the handle, the opening being sealed by a cap incorporating an integral bore-sealing annulus thereby allowing its production from a single polymer if desired. The cap may be screwthreaded for engagement with a complementary screwthread on the handle.

The cap may be produced using a open/shut “jump off” injection moulding tool which allows the thread on the cap to be produced without having to unscrew the tool and cap from one another. The cap may be moulded from a low density polyethylene. Use of LDPE, desirably with an anti-slip agent incorporated, for production of the cap facilitates “jump off”.

The outlet and the valve member which co-operates with the outlet may be shaped in such a way that one has a convex configuration and the other a concave configuration such that the convex formation seals against the rim of the convex formation. As indicated previously, the materials of the contacting formations may be different, e.g. the concave formation may be of a more flexible and/or softer plastics material than than the convex formation or vice versa.

To facilitate sealing of the outlet and the valve member, the outlet may be formed in a wall of the handle which has enhanced flexibility compared for example with the hand grip portion of the handle. Such enhanced flexibility may be achieved by moulding the wall with one or more annular corrugations or ripples surrounding the outlet.

The invention will now be described by way of example only with reference to the accompanying drawings, in which:

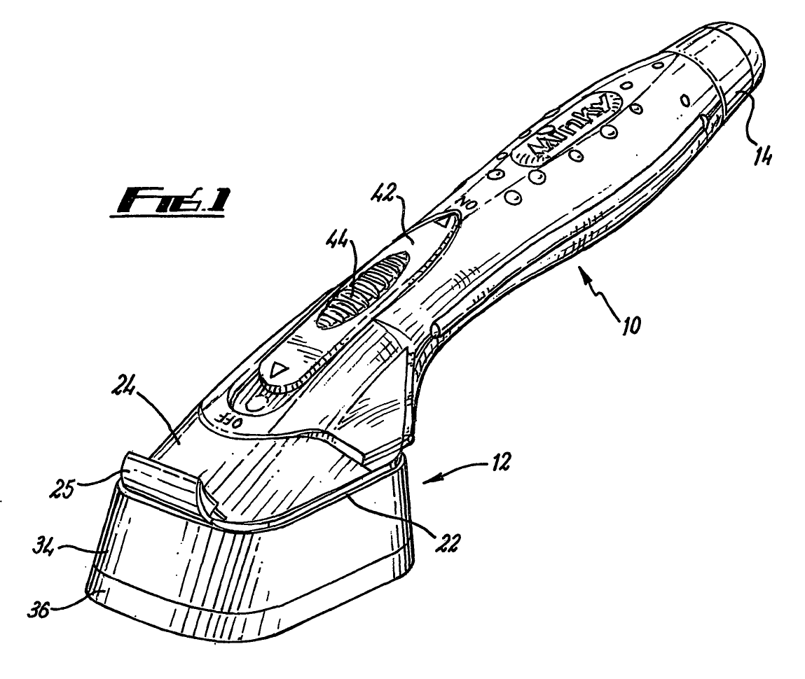

FIG. 1 is a perspective view of the utensil;

FIG. 2 is a longitudinal sectional view of the utensil with the actuator shown in its liquid dispensing position;

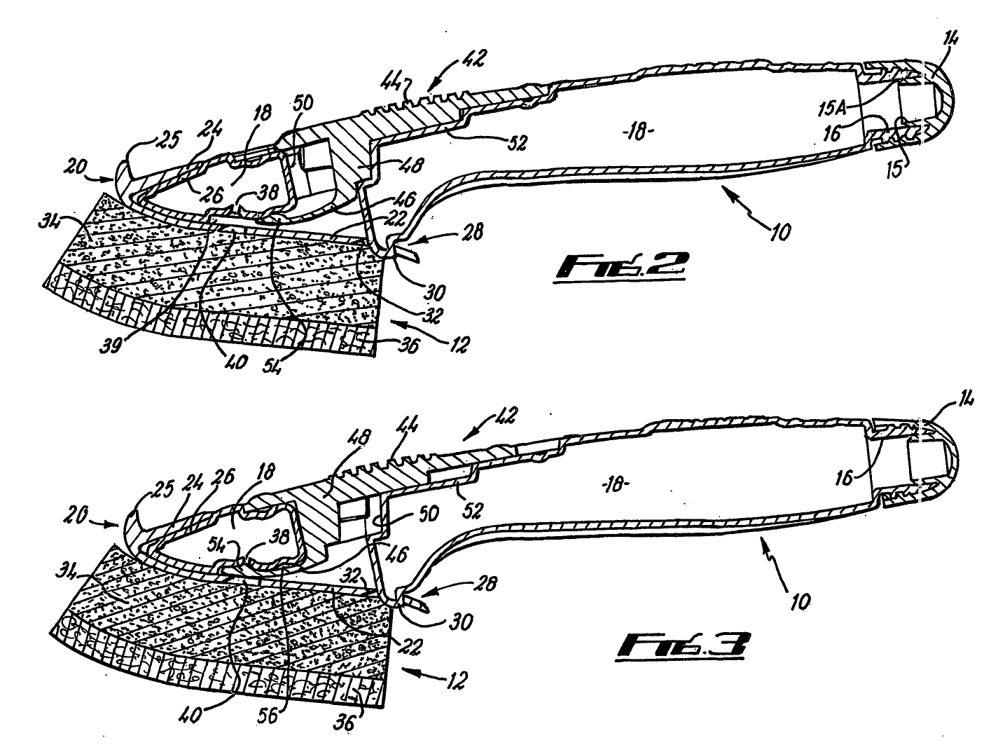

FIG. 3 is a similar view to that of FIG. 2 but showing the actuator in the outlet closure position;

FIG. 4 is an enlarged fragmentary view illustrating undercutting of a projection 30 for retaining the head engaged with the handle;

FIG. 5 is a perspective view of the body portion of the head prior to attachment of a foam pad thereto by hot air staking;

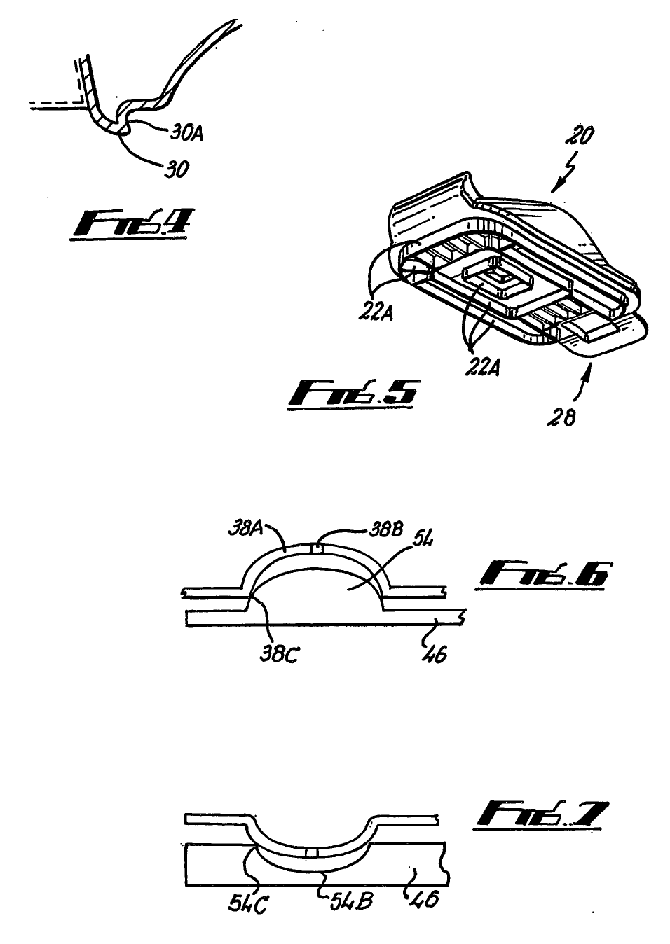

FIGS. 6 and 7 are diagrammatic views illustrating sealing of the outlet in the hollow handle;

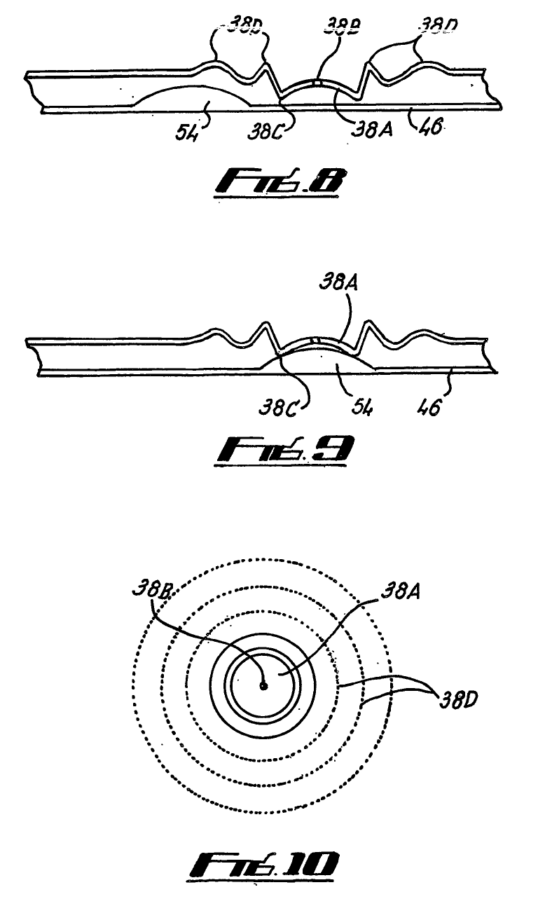

FIGS. 8 and 9 are fragmentary views showing an alternative form of outlet sealing arrangement involving use of a corrugated diaphragm; and

FIG. 10 is a diagrammatic underside view of the corrugated diaphragm.

Referring now to the drawings, a kitchen cleaning utensil comprises a hollow handle 10 and a cleaning head 12 fitted to the forward end of the handle. The handle 10 may be formed of a relatively soft and flexible plastics material such as high density polyethylene, a convenient manufacturing technique being blow-moulding. At its rearward end, the handle is provided with a removable sealing cap 14 which is screw-threadedly engaged with an inlet 16 of the handle. The sealing cap is produced with an internal thread and an integral annular bore seal 15 which engages and seals with the internal periphery of the inlet 16 as the cap is screwed onto that end of the handle. The annular seal may be of conical configuration at least on its external surface so that its sealing engagement with the internal surface of the inlet progressively increases as the seal moves into the inlet. The seal may also include a lead-in portion 15A as illustrated. The sealing cap may be produced as an injection moulding of a low density polyethylene and, as mentioned previously, may be produced using a “jump off” injection moulding tool so that the thread can be achieved without having to unscrew the tool and the cap from one another. This may be facilitated by incorporating an anti-slip agent in the polymer.

The interior of the handle forms a liquid-receiving reservoir 18 which extends from the rear end of the handle to its forward end. The interior of the handle is, in use, filled with liquid, such as a liquid detergent, via the inlet 16. The cleaning head 12 includes a shoe 20 having a base 22 which fits against a lower surface of the handle, the base 22 being formed with a lip 24 forming with the base a pocket for reception and guidance of the adjacent forward end portion 26 of the handle.

Attachment of the base 22 to the handle is completed by a clip arrangement 28 comprising a projection 30 on the handle received with snap engagement in an aperture 32 at the rear end of the base. The shoe is made, e.g. as a single piece plastics moulding, of a resiliently deformable material, e.g. polypropylene, which may be less flexible and harder than the material used for production of the handle 10 but is sufficiently flexible that the cleaning head 12 can be detached from the handle by flexing the base 22 to disengage the projection 30 and aperture 32. The projection 30 may be formed integrally with the handle, e.g. during blow-moulding of the latter, and may have an undercut region 30A as shown in FIG. 4.

In the illustrated embodiment, the cleaning head 12 comprises a layer 34 of foam or sponge type material and a layer 36 of material suitable for scouring pots, pans and such like. The foam material is adhered to the underside of the base 22 without the aid of any glue or adhesive material, e.g. by means of hot air staking. To this end, the underside of the base 22 may be provided with integral ribs or upstands 22A as indicated in FIG. 5 which, during hot air staking, are caused to melt to some degree so that the layer 34 of foam can be pressed onto the at least partially molten ribs or upstands to bond the foam to the base 22. This method of attachment affords such effective bonding that the underside of the base 22 may be curved upwardly adajcent its forward end and the foam bonded to the shoe over that curved region. Such curved configuration at the underside of the shoe facilitates access into the corners of items such as mugs to allow effective cleaning.

An alternative cleaning head may be in the form of other scouring or cleaning elements/materials such as a brush with bristles extending from the base 22. In practice, the same handle may be used with the different types of cleaning head simply by detaching one and substituting another, according to the particular task to be carried out. The forward end of the shoe is upturned to form a scraper 25.

Liquid is dispensed from the interior of the handle into the cleaning head through an outlet 38 in the lower surface of the handle, the outlet 38 being in registry with an aperture 40 in the base 22 when the cleaning head is fitted to the handle. The outlet 38 comprises a small opening at the base of a recess 39 in the wall of the handle.

Opening and closing of the outlet 38 is accomplished by means of an actuator 42 mounted for sliding movement on the handle between the positions shown in FIGS. 2 and 3. The actuator 42 comprises a finger or thumb portion 44 located on the upper side of the handle, a tongue 46 extending along the lower side of the handle and a bridging portion 48 which extends through a slot or throughbore 50 in the handle, the slot 50 being elongated in the longitudinal direction relative to the handle and extending from one side of the handle to the opposite side to provide a passageway which does not penetrate into the interior of the hollow handle in such a way as to allow communication between the forward end of the handle and its rearward end. The tongue 46 is slidable to and fro in a space located between the lower surface of the handle and the upper surface of the shoe base 22. The upper side of the handle is formed with a channel 52 which seats the finger/thumb portion 44 for sliding movement longitudinally of the handle. It will be seen that the actuator extends from one side of the handle to the other without penetrating the hollow interior of the handle thereby obviating any need for sealing between the handle and the actuator.

The actuator 42 is produced as a one-piece plastics moulding, e.g. from polypropylene, and the tongue 46 is made sufficiently thin as to be flexibly deformable. Adjacent its free end, the tongue 46 is provided with an integral projection 54 forming a valve head for co-operation with the outlet 38. In the closed position of the actuator, the projection 54 seats in the recess 39 and seals the outlet. In this position, it also acts as a detent in that rearward sliding of the actuator is resisted by the flexible tongue which biases the projection 54 into the recess 39.

Application of modest effort however is sufficent to overcome the resistance afforded by the flexible tongue and appropriate operation of the actuator 42 withdraws the projection 54 rearwardly to open the outlet 38 and allow liquid flow into the cleaning head. In the fully open position (see FIG. 2), the projection 54 seats in a second recess 56 located on the lower surface of the handle to the rear of the recess 39. Again the projection 54 together with the recess 56 provides a detent action which, by virtue of the resilient nature of the tongue, serves to resist movement of the actuator from the open position to the closed position.

The outlet 38 and the projection 54 are configured as more clearly illustrated in FIG. 6. As shown, the outlet 38 comprises a concavely domed portion 38A formed with an opening 38B and having a rim 38C. The projection 54 is convex and the curvatures of the projection 54 and domed portion 38A are dissimilar so that when the projection 54 registers with the domed portion 38A, it does not “bottom” in the domed portion; instead it makes sealing contact with the rim 38C thereby affording an effective seal. In a modification as shown in FIG. 7, instead of the outlet being concavely domed and the tongue carrying a convex projection for co-operation with the outlet, the configuration may be reversed so that the outlet 38 is convex and is sealed by entry into a recess 54B in the tongue 46 in such a way that the seal is effected at the rim 54C of the recess 54B. En each case, sealing is further enhanced by virtue of the materials of the tongue 54 and the handle being dissimilar in hardness and/or flexibility, e.g. polypropylene in the case of the tongue 54 and high density polyethylene in the case of the handle.

FIGS. 8, 9 and 10 illustrate another modification for the valve arrangment. In this case, the valve outlet 38 comprises a domed portion 38A with a valve opening 38B and rim 38C and one or more annular corrugations 38D surrounding the domed portion 38A. The corrugations may be readily formed during the blow-moulding process. In this manner, the corrugations create a resiliently deformable corrugated diaphragm arrangement which enhances the flexibility of the wall in which the outlet 38 is formed. It will be seen from FIG. 8 that the domed portion 38A obstructs or interferes the path of sliding movement of the projection 54 carried by tongue 46. As the tongue 46 moves to the closure position, the projection 54 deflects the domed portion 38A upwardly against the resilient downward biasing force of the diaphragm arrangement and eventually seats within the domed portion 38 as shown in FIG. 9 to make sealing contact with the rim 38C. The valve is re-opened by displacing the tongue and projection 54 back to the position of FIG. 8.

It will be understood that the modification illustrated in FIG. 7 may also be applied to the valve arrangement shown in FIGS. 8 to 10 using a downwardly convex domed portion seating in a recess in the tongue 46.

In the illustrated embodiment, the valve member is movable linearly between the closed and open positions. However, we do not exclude the possibility of the valve member being movable angularly, e.g. rotatably, between the closed and open positions with the actuator being adapted accordingly. Detent means or the like may be associated with the actuator to hold the actuator in desired locations, i.e. the valve open and closed positions.

Whilst endeavouring in the foregoing specification to draw attention to those features of the invention believed to be of particular importance, it should be understood that the Applicant seeks protection in respect of any patentable feature or combination of features disclosed herein and/or shown in the drawings whether or not particular emphasis has been placed on such feature or features.

1. A cleaning utensil comprising a hollow, liquid-receiving handle having an outlet, a cleaning head in registry with the outlet and an actuator provided on the handle for opening and closing the outlet, the actuator including a valve member for opening and closing the outlet, the handle having a through-bore passing from one side of the handle to the other for accommodating the actuator whereby the actuator extends through the handle without requiring sealing.

2. A utensil as claimed in claim 1 in which the actuator is slidable and includes a valve member which is slidable across the outlet to effect opening and closing.

3. A utensil as claimed in claim 1 or 2 in which the valve member is movable linearly between the opening and closing positions.

4. A utensil as claimed in claim 1 in which movement of the valve member between its opening and closing positions involves a rotary component of movement.

5. A utensil as claimed in any one of claims 1 to 4 in which the actuator is a one-piece moulding incorporating the valve member.

6. A utensil as claimed in any one of claims 1 to 5 in which the valve member is so arranged that, in one position of the actuator it closes the outlet and, in a second position, it acts as a detent to hold the actuator in the second position.

7. A utensil as claimed in any one of claims 1 to 6 in which the actuator comprises a first part located on one side of the handle and accessible to the user while holding the handle, a second part which extends through the handle and a third part which extends alongside the opposite side of the handle and is provided with the valve member.

8. A utensil as claimed in claim 7 in which the third part of the actuator is in the form of a flexible tongue which biases the valve member inwardly with respect to the outlet

9. A utensil as claimed in claim any one of claims 1 to 8 in which the outlet is provided in a domed portion for co-operation with the valve member.

10. A utensil as claimed in claim 9 in which the domed portion is concave and the valve member includes a convex formation for reception in the domed portion.

11. A utensil as claimed in claim 9 in which the domed portion is convex and the valve member includes a concave formation which receives the domed portion.

12. A utensil as claimed in claim 10 or 11 in which the domed portion and said formation have dissimilar contours such that the sealing contact is made around the rim of the concavity.

13. A utensil as claimed in any one of claims 1 to 12 in which the region of the handle in which the outlet is provided has enhanced flexibility.

14. A utensil as claimed in claim 13 in which the enhanced flexibility is provided by one or more annular corrugations surrounding the outlet such that said region forms a corrugated diaphragm.

15. A utensil as claimed in any one of claims 1 to 14 in which the arrangement is such that operation of the actuator moves the valve member from the outlet closing position to the opening position in which it is maintained by a detent action.

16. A utensil as claimed in any one of claims 1 to 15 in which the cleaning head is detachable from the handle.

17. A utensil as claimed in claim 16 in which the handle has at one end a surface which interfaces with a shoe portion of the cleaning head and the shoe portion is designed to clip on to that end of the handle.

18. A utensil as claimed in claim 16 in which the shoe includes an aperture for registry with the outlet of the handle so that liquid flow from the handle passes through the shoe into a cleaning feature or features of the cleaning head.

19. A utensil as claimed in any one of claims 1 to 18 in which a valve member-carrying part of the actuator is located and movable between the head and an adjacent surface of the handle.

20. A utensil as claimed in any one of the preceding claims in which the handle is produced by blow moulding.

21. A utensil as claimed in any of the preceding claims in which the handle and the head are moulded from different plastics materials.

22. A utensil as claimed in claim 21 in which the handle is moulded from a more flexible and/or softer plastics material than the head and/or the actuator.

23. A utensil as claimed in any one of the preceding claims in which the handle is composed of a highly density polyethylene.

24. A utensil as claimed in any one of the preceding claims in which the head and/or the actuator is moulded from a polypropylene.

25. A utensil as claimed in which the handle is provided with a removable sealing cap which is moulded from a low density polyethylene.

26. A utensil as claimed in any one of the preceding claims in which a latching arrangement is provided for coupling the head to the handle.

27. A utensil as claimed in claim 26 in which the latching arrangement includes a projection having an undercut face for co-operation with a latching member on the head.

28. A utensil as claimed in claim 27 in which the projection is formed integrally with the handle during blow-moulding of the latter.

29. A utensil as claimed in any one of claims 27 to 28 in which the latching member on the head is in the form of an aperture for receiving the handle projection with snap engagement such that one side of the aperture rides over the projection and into the undercut region of the projection.

30. A utensil as claimed in any one of the preceding claims in which the head comprises a body portion and a foam pad attached to the body portion.

31. A utensil as claimed in claim 29 in which the foam pad is bonded to the body portion of the head without the aid of an adhesive or glue.

32. A utensil as claimed in claim 31 in which the foam pad is bonded to the body portion by hot air staking.

33. A utensil as claimed in any one of the preceding claims in which the handle has an opening through which liquid can be introduced into the interior of the handle, the opening being sealed by a cap incorporating an integral bore-sealing annulus.
